(19) United States
(12) Patent Application Publication
(10) Pub. No.: US 2018/0023600 A1
(43) Pub. Date: Jan. 25, 2018

(54) FLUID SUPPLY PIPE

(71) Applicant: SIO CO., LTD., Tokyo (JP)

(72) Inventors: Masuhiko Komazawa, Tokyo (JP); Masaru Ohki, Tokyo (JP)

(21) Appl. No.: 15/620,930

(22) Filed: Jun. 13, 2017

(30) Foreign Application Priority Data
Jul. 25, 2016 (KR) 2016-0094458

(51) Int. Cl. F15D 1/00; B01F 5/06; B23Q 11/10; B24B 55/03; B05B 1/34; F15D 1/02

(52) U.S. Cl. CPC F15D 1/0015; B05B 1/341; F15D 1/02; B23Q 11/10; B24B 55/03; B01F 5/0614; B01F 5/0612; B01F 5/0676; B01F 5/0672; B01F 2005/0634

(57) ABSTRACT

A fluid supply pipe according to an embodiment of the invention includes an internal structure and a pipe body configured to house the internal structure. The pipe body has an inlet and an outlet and has a circular cross-section. The internal structure includes a first portion for diffusing a fluid flowing into the fluid supply pipe through the inlet radially from the center of the fluid supply pipe, the first portion being placed in the inlet side of the pipe body when the internal structure is housed in the pipe body, a second portion placed downstream from the first portion and including a plurality of spiral vanes to swirl the fluid diffused by the first portion, and a third portion placed downstream from the second portion and including a plurality of protrusions on its outer circumferential surface.

### CROSS-REFERENCE TO RELATED APPLICATIONS

This application is based upon and claims the benefit of priority under 35 USC 119 of Korean Patent Application No. 2016-0094458 filed on Jul. 25, 2016, the entire disclosure of which is incorporated herein by reference in its entirety for all purposes.

### BACKGROUND OF THE INVENTION

### 1. Field of the Invention

The present invention relates to a fluid supply pipe for an apparatus for supplying a fluid. More specifically, the present invention relates to a fluid supply pipe which applies a predetermined flow characteristic to a fluid flowing therethrough. For example, the fluid supply pipe of the present invention is applicable to a cutting fluid supply apparatus for various machine tools such as a grinding machine, a drilling machine, and a cutting machine.

### 2. Description of the Related Art

Conventionally, when a workpiece made of a metal or the like is machined into a desired shape by a machine tool such as the grinding machine or the drilling machine, a machining fluid (for example, coolant) is supplied to a contact portion between the workpiece and a tool (for example, a blade) in order to cool heat generated during machining or remove debris of the workpiece (also referred to as chips) from a machining spot. Cutting heat caused by high pressure and frictional resistance at the contact portion between the workpiece and the blade abrades the edge of the blade and lowers the strength of the blade, thereby reducing tool life of the blade. In addition, if the chips of the workpiece are not sufficiently removed, they can stick to the edge of the blade during machining, which may degrade machining accuracy.

The machining fluid (also referred to as a cutting fluid) decreases the frictional resistance between the tool and the workpiece, removes the cutting heat, and performs cleaning to remove the chips cut off from a surface of the workpiece. For this, the machining fluid should have a low coefficient of friction, a high boiling point, and good penetration into the contact portion between the blade and the workpiece.

For example, Japanese Patent Application Laid-Open Publication No. 1999-254281 published on Sep. 21, 1999 (published also as U.S. Pat. No. 6,095,899), discloses providing a gas emitting means for emitting a gas (for example, air) in a machining apparatus in order to forcibly infiltrate a machining liquid into a contact portion between a working element (i.e. a blade) and a workpiece.

According to the conventional technology as disclosed in the above patent document, the means for emitting the gas at a high speed and high pressure should be provided in the machining apparatus in addition to a means for spraying the machining liquid, thus increasing the cost and the size of the apparatus. Further, in the grinding machine, the machining liquid cannot sufficiently reach a contact portion between a grindstone and the workpiece because the air rotates along the outer circumferential surface of the grindstone together with the grindstone rotating at a high speed. Thus, there is still a problem that it is difficult to cool the heat generated during machining sufficiently because the machining liquid cannot sufficiently penetrate into the contact portion by simply emitting the air in the same direction as the rotation direction of the grindstone.

### SUMMARY OF THE INVENTION

The present invention was made in light of the problems mentioned above. An object of the present invention is to provide a fluid supply pipe for applying a predetermined flow characteristic to a fluid flowing therethrough to improve lubricity, penetration, and a cooling effect of the fluid.

In order to achieve the above object, an embodiment of the present invention provides a fluid supply pipe including an internal structure and a pipe body configured to house the internal structure. The pipe body has an inlet and an outlet and has a circular cross-section. The internal structure includes a first portion for diffusing a fluid flowing into the fluid supply pipe through the inlet radially from the center of the fluid supply pipe, the first portion being placed in the inlet side of the pipe body when the internal structure is housed in the pipe body, a second portion placed downstream from the first portion and including a plurality of spiral vanes to swirl the fluid diffused by the first portion, and a third portion placed downstream from the second portion and including a plurality of protrusions on its outer circumferential surface.

Another aspect of the present invention provides an internal structure of a fluid supply pipe which comprises a pipe body having an inlet and an outlet. The internal structure includes a fluid diffusing portion for diffusing a fluid flowing into the fluid supply pipe through the inlet radially from the center of the fluid supply pipe, the fluid diffusing portion being placed in the inlet side of the pipe body when the internal structure is housed in the pipe body, a swirl generating portion placed downstream from the fluid diffusion portion for swirling the fluid diffused by the fluid diffusion portion, and a bubble generating portion placed downstream from the swirl generating portion for generating multi bubbles in the fluid swirled by the swirl generating portion.

If the fluid supply pipe according to some embodiments of the present invention is provided in a fluid supply unit of a machine tool or the like, a cleaning effect is improved over the prior art due to vibration and impact generated during a process in which a plurality of micro bubbles generated in the fluid supply pipe collide with the tool and the workpiece and break. Thus, the life of the tool such as the cutting blade can be extended and the cost of replacing the tool can be reduced. In addition, the characteristic applied by the fluid supply pipe according to some embodiments of the present invention can increase the cooling effect and improve the lubricity by increasing penetration of the fluid, thereby enhancing the precision of machining.

Further, according to many embodiments of the present invention, the internal structure of the fluid supply pipe is manufactured as one integrated component. Therefore, assembly of the internal structure with a pipe body is simplified.

The fluid supply pipe can be applied to a machining fluid supply unit in various machine tools such as the grinding machine, the cutting machine, and the drilling machine. In addition, it can be effectively used in an apparatus for mixing two or more fluids (liquid and liquid, liquid and gas, or gas and gas).

### BRIEF DESCRIPTION OF THE DRAWINGS

The above and further objects and novel features of the present invention will more fully appear from the following detailed description when the same is read in conjunction with the accompanying drawings. It is to be expressly understood, however, that the drawings are for the purpose of illustration only and are not intended to limit the scope of the invention.

Here:

FIG. 1 shows a grinding machine including a fluid supply unit to which the present invention is applied.

FIG. 2 is a side exploded view of a fluid supply pipe according to a first embodiment of the present invention.

FIG. 3 is a side sectional view of the fluid supply pipe according to the first embodiment of the present invention.

FIG. 4 is a three-dimensional perspective view of an internal structure of the fluid supply pipe according to the first embodiment of the present invention.

FIG. 5 is a drawing for explaining a method for forming rhombic protrusions of the internal structure of the fluid supply pipe according to the first embodiment of the present invention.

FIG. 6 is a side exploded view of a fluid supply pipe according to a second embodiment of the present invention.

FIG. 7 is a side sectional view of the fluid supply pipe according to the second embodiment of the present invention.

FIG. 8 is a three-dimensional perspective view of an internal structure of the fluid supply pipe according to the second embodiment of the present invention.

FIG. 9 is a side exploded view of a fluid supply pipe according to a third embodiment of the present invention.

FIG. 10 is a side sectional view of the fluid supply pipe according to the third embodiment of the present invention.

FIG. 11 is a side exploded view of a fluid supply pipe according to a fourth embodiment of the present invention.

FIG. 12 is a side sectional view of the fluid supply pipe according to the fourth embodiment of the present invention.

FIG. 13 is a side exploded view of a fluid supply pipe according to a fifth embodiment of the present invention.

FIG. 14 is a side sectional view of the fluid supply pipe according to the fifth embodiment of the present invention.

FIG. 15 is a side exploded view of a fluid supply pipe according to a sixth embodiment of the present invention.

FIG. 16 is a side sectional view of the fluid supply pipe according to the sixth embodiment of the present invention.

### DETAILED DESCRIPTION OF THE PREFERRED EMBODIMENT

Embodiments in which the present invention is applied to machine tools such as a grinding machine will be mainly described herein. However, the field of application of the present invention is not intended to be limited to the illustrated examples. The present invention is applicable to various situations requiring supply of a fluid, such as a household shower nozzle or a fluid mixing apparatus.

Hereinafter, the embodiments of the present invention will be described with reference to the accompanying drawings.

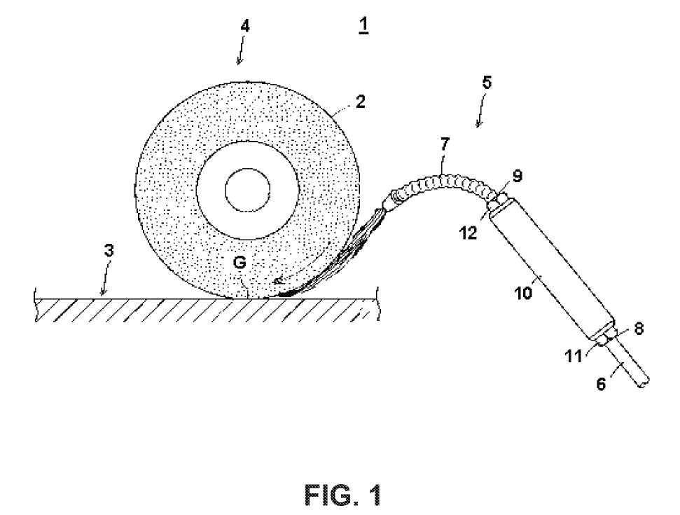

FIG. 1 shows an embodiment of a grinding machine including a fluid supply unit to which the present invention is applied. As shown, a grinding machine 1 includes a grinding unit 4 including a grinding blade (a grindstone) 2, a table for moving a workpiece 3 in two dimensions (not shown), and a column for vertically moving the workpiece or the grinding blade (not shown), and a fluid supply unit 5 for supplying a fluid (i.e. coolant) to the grinding blade or the workpiece. The grinding blade 2 is rotationally driven in the clockwise direction in the plane of FIG. 1 by a driving source (not shown in the drawing). A surface of the workpiece 3 is ground by friction between the outer circumferential surface of the grinding blade 2 and the workpiece 3 at a grinding spot G. Although not shown in the drawing, the fluid supply unit 5 includes a tank in which the coolant (for example, water) is stored and a pump for discharging the coolant from the tank.

The fluid supply unit 5 includes a delivery pipe 6 into which a fluid stored in the tank is flowed by the pump, a fluid supply pipe 10 having an internal structure for applying a predetermined flow characteristic to the fluid, and a nozzle 7 having a discharge port disposed close to the grinding spot G. The fluid supply pipe 10 and the delivery pipe 6 are connected, for example, by engaging a female screw of a nut 11 which is a connecting member provided on the side of the inlet 8 of the fluid supply pipe 10 with a male screw (not shown in the drawing) formed on the outer peripheral surface of one end of the delivery pipe 6 (by thread cutting, for example). The fluid supply pipe 10 and the nozzle 7 are connected, for example, by engaging a female screw of a nut 12 which is a connecting member provided on the side of the outlet 9 of the fluid supply pipe 10 with a male screw (not shown in the drawing) formed on the outer peripheral surface of one end of the nozzle 7 (by thread cutting, for example). The fluid flowing into the fluid supply pipe 10 from the delivery pipe 6 has a predetermined flow characteristic applied by the internal structure while passing though the fluid supply pipe 10. The fluid is discharged toward the grinding spot G through the outlet 9 of the fluid supply pipe 10 and the nozzle 7. According to many embodiments of the present invention, the fluid passing through the fluid supply pipe includes micro bubbles. Hereinafter, various embodiments of the internal structure of the fluid supply pipe will be described with reference to the drawings.

### First Embodiment

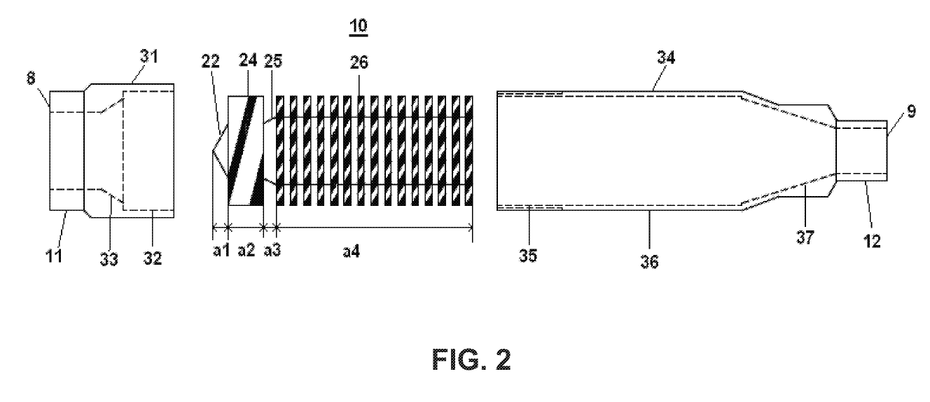

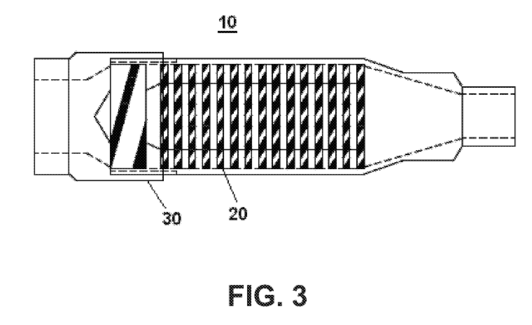

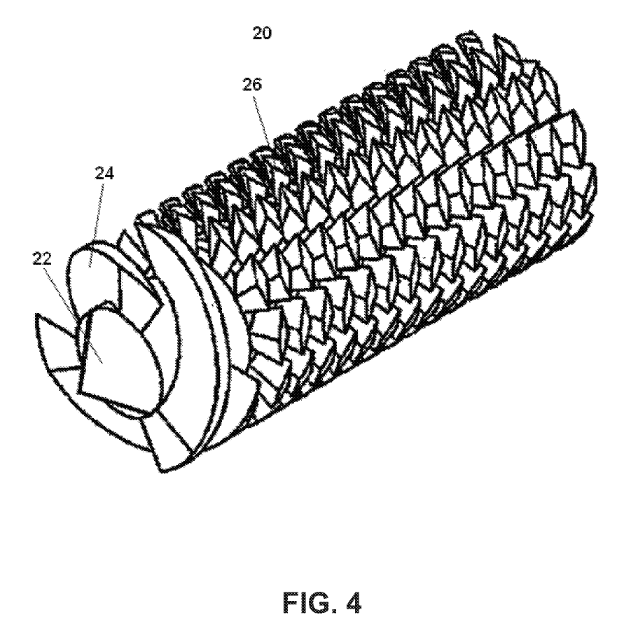

FIG. 2 is a side exploded view of the fluid supply pipe 10, FIG. 3 is a side sectional view of the fluid supply pipe 10, and FIG. 4 is a three-dimensional perspective view of an internal structure 20 of the fluid supply pipe 10, according to a first embodiment of the present invention. In FIGS. 2 and 3, the fluid flows from the inlet 8 to the outlet 9. As shown in FIGS. 2 and 3, the fluid supply pipe 10 includes the internal structure 20 and a pipe body 30.

The pipe body 30 includes an inlet side member 31 and an outlet side member 34. Each of the inlet side member 31 and the outlet side member 34 is formed in a hollow tube shape. The inlet side member 31 has the inlet 8 having a predetermined diameter at one end and a female screw 32 at the other end which is formed by thread-cutting an inner circumferential surface for connection with the outlet side member 34. As explained with respect to FIG. 1, the nut 11 is integrally formed with the inlet 8. As shown in FIG. 2, the inner diameters of the both ends of the inlet side member 31, i.e. the inner diameter of the inlet 8 and the inner diameter of the female screw 32 are different from each other, and the inner diameter of the inlet 8 is smaller than the inner diameter of the female screw 32. A tapered portion 33 is formed between the inlet 8 and the female screw 32. Although the nut 11 is formed as a part of the inlet side member 31 in the present embodiment, the present invention is not limited to this embodiment. In another embodiment, the nut 11 is manufactured as a separate component from the inlet side member 31 and connected to an end of the inlet side member 31.

The outlet side member 34 has the outlet 9 having a predetermined diameter at one end and a male screw 35 at the other end which is formed by thread-cutting an outer circumferential surface for connection with the inlet side member 31. The diameter of the outer circumferential surface of the male screw 35 of the outlet side member 34 is the same as the inner diameter of the female screw 32 of the inlet side member 31. As explained with respect to FIG. 1, the nut 12 is integrally formed with the outlet 9. A tubular portion 36 and a tapered portion 37 are formed between the nut 12 and the male screw 35. The inner diameters of the both ends of the outlet side member 34, i.e. the inner diameter of the outlet 9 and the inner diameter of the male screw 35 are different from each other, and the inner diameter of the outlet 9 is smaller than the inner diameter of the male screw 35. Although the nut 12 is formed as a part of the outlet side member 34 in the present embodiment, the present invention is not limited to this embodiment. In another embodiment, the nut 12 is manufactured as a separate component from the outlet side member 34 and connected to an end of the outlet side member 34. The pipe body 30 is formed by connecting the inlet side member 31 and the outlet side member 34 by screw-joining the female screw 32 of the inner circumferential surface of the inlet side member 31 and the male screw 35 of the outer circumferential surface of the outlet side member 34.

The above described configuration of the pipe body 30 is merely an embodiment, and the present invention is not limited to the configuration. For example, connection of the inlet side member 31 and the outlet side member 34 is not limited to the screw-joining and any method for connecting mechanical components known in the art is applicable. Further, the shapes of the inlet side member 31 and the outlet side member 34 are not limited to ones shown in FIGS. 2 and 3, respectively. A designer of the fluid supply pipe 10 may arbitrarily design them or change the shapes according to applications of the fluid supply pipe 10. Each of the inlet side member 31 and the outlet side member 34 can be made of a metal such as steel, plastic, or the like.

Referring to FIG. 3 together, the fluid supply pipe 10 is assembled by engaging the male screw 35 of the outer circumferential surface of the outlet side member 34 with the female screw 32 of the inner circumferential surface of the inlet side member 31 after inserting the internal structure 20 in the outlet side member 34. The internal structure 20 can be formed by processing a cylindrical member made of a metal such as steel or by molding plastic, for example. As shown in FIGS. 2 and 4, the internal structure 20 includes a fluid diffusing portion 22, a swirl generating portion 24, and a bubble generating portion 26.

In the present embodiment, the fluid diffusing portion 22 can be formed by machining (for example, spinning) one end of a cylindrical member in a cone shape. The fluid diffusing portion 22 diffuses the fluid flowing into the inlet side member 31 through the inlet 8 outward from the center of the pipe, i.e. radially.

The swirl generating portion 24 is formed by machining a part of the cylindrical member and includes a shaft portion having a circular cross-section and three spiral vanes, as shown in FIG. 4. Referring to FIG. 2, the length of the swirl generating portion 24 (a2) is longer than the length of the fluid diffusing portion 22 (a1) and is shorter than the length of the bubble generating portion 26 (a4) in the present embodiment. Further, it is preferable that the radius of a portion of the fluid diffusing portion 22 of which cross-sectional area is the maximum, is smaller than the radius of the swirl generating portion 24 (i.e. the distance from the center of the shaft portion to the end of each of the vanes). Each of the vanes of the swirl generating portion 24 has its end spaced by 120 degrees from each other in the circumferential direction of the shaft portion. The vanes are formed in a spiral shape in the counterclockwise direction at a predetermined interval on the outer circumferential surface from one end to the other end of the shaft portion. The number of the vanes is three in the present invention, but the present invention is not limited thereto. Further, the shape of the vanes of the swirl generating portion 24 is not particularly limited if the vanes can cause swirling flow of the fluid which has been diffused through the fluid diffusing portion 22 and has flowed into the swirl generating portion 24 while the fluid passes between the vanes. In the present embodiment, the outer diameter of the swirl generating portion 24 is such that it is close to the inner peripheral surface of the outlet side member 34 of the pipe body 30 when the internal structure 20 is housed in the pipe body 30.

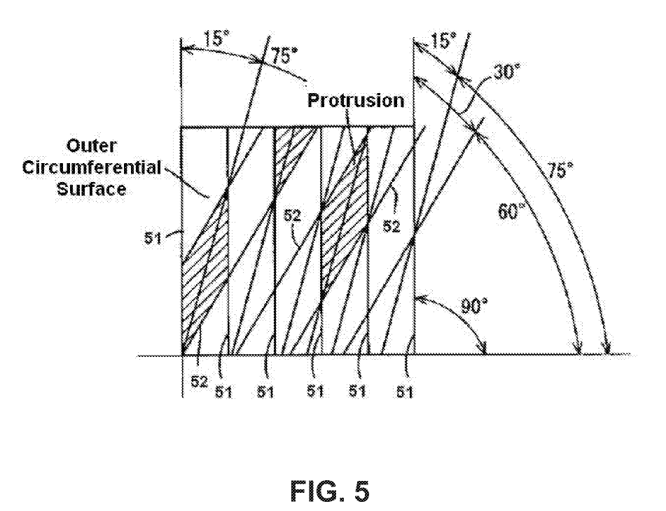

The bubble generating portion 26 is formed by machining the downstream portion of the cylindrical member, that is, a portion of the cylindrical member remaining after forming the fluid diffusion portion 22 and the swirl generating portion 24. As shown in FIGS. 2 and 4, a plurality of rhombic (i.e. diamond-shaped) protrusions are formed in a net shape on the outer circumferential surface of a shaft portion having a circular cross-section of the bubble generating portion 26. Each of the plurality of rhombic protrusions can be formed, for example, by grinding the cylindrical member so as to protrude outward from the outer circumferential surface of the shaft portion. More specifically, FIG. 5 shows an exemplary method for forming the rhombic protrusions. A plurality of lines 51 with predetermined spacing therebetween in the direction of 90 degrees with respect to the longitudinal direction of the cylindrical member and a plurality of lines 52 having a predetermined angle (for example, 60 degrees) with respect to the longitudinal direction with predetermined spacing therebetween are intersected with each other. Spaces between the line 51 and the line 51 are ground alternately, and spaces between the tilted line 52 and the tilted line 52 are ground alternately. By this, the plurality of rhombic protrusions protruding from the outer circumferential surface of the shaft portion are formed regularly and alternately in the vertical direction (the circumferential direction of the shaft portion) and the horizontal direction (the longitudinal direction of the shaft portion). Further, in the present embodiment, the outer diameter of the bubble generating portion 26 is such that it is close to the inner circumferential surface of the outlet side member 34 of the pipe body 30 when the internal structure 20 is housed in the pipe body 30.

In the present embodiment, the diameter of the shaft portion of the swirl generating portion 24 is smaller than the diameter of the shaft portion of the bubble generating portion 26, as shown in FIG. 2. Thus, there is a tapered portion 25 (length: a3) between the swirl generating portion 24 and the bubble generating portion 26. However, the present invention is not limited thereto. In another embodiment, the swirl generating portion 24 and the bubble generating portion 26 have the same diameter.

Hereinafter, flow of the fluid passing through the fluid supply pipe 10 will be described. The fluid enters the inlet 8 of the fluid supply pipe 10 through the delivery pipe 6 (see FIG. 1) by an electric pump whose impeller rotates clockwise or counterclockwise. The fluid bumps into the fluid diffusing portion 22 and diffuses outward from the center of the fluid supply pipe 10 (i.e. radially) while passing through the inner space of the tapered portion 33 of the inlet side member 31. The diffused fluid passes between the three vanes of the swirl generating portion 24 formed in the spiral shape in the counterclockwise direction. The fluid diffusing portion 22 induces the fluid flowing into the fluid supply pipe 10 through the delivery pipe 6 to enter the swirl generating portion 24 effectively. The fluid vigorously swirls due to the vanes of the swirl generating portion 24 and is sent to the bubble generating portion 26 through the tapered portion 25.

Then, the fluid passes between the plurality of rhombic protrusions formed regularly on the outer circumferential surface of the shaft portion of the bubble generating portion 26. The plurality of rhombic protrusions form a plurality of narrow flow paths. As the fluid passes through the plurality of narrow flow paths formed by the plurality of rhombic protrusions, a flip-flop phenomenon (a phenomenon occurring when the direction in which a fluid flows changes alternately and periodically) occurs to generate a large number of minute vortices. Due to the flip-flop phenomenon, the fluid passing between the plurality of protrusions of the bubble generating unit 26 in the fluid supply pipe 10 flows with directions being changed alternately in a periodic manner, which causes mixing and diffusion of the fluid. The structure of the bubble generating unit 26 is also useful when two or more fluids having different properties need to be mixed.

The internal structure 20 is configured such that the fluid flows from the upstream side (the swirl generating portion 24) having a large cross-sectional area to the downstream side (the flow paths formed between the plurality of rhombic protrusions of the bubble generating portion 26) having a small cross-sectional area in the fluid supply pipe 10. This configuration changes static pressure of the fluid as described below. The relationship between pressure, velocity, and potential energy with no external energy to a fluid is given by the Bernoulli equation.

$$p + \frac{ρ {υ}^{2}}{2} + gh ρ = k$$

Here, p is the pressure at a point on a streamline, p is the density of the fluid, v is the fluid flow speed at the point, g is the gravitational acceleration, h is the height of the point with respect to a reference plane, and k is a constant. The Bernoulli's law expressed as the above equation is the energy conservation law applied to fluids and explains that the sum of all the forms of energy on a streamline is constant for flowing fluids at all times. According to the Bernoulli's law, the fluid velocity is low and the static pressure is high in the upstream side having the large cross-sectional area. On the other hand, the fluid velocity is increased and the static pressure is lowered in the downstream side having the small cross-sectional area.

In the case that the fluid is a liquid, the liquid begins to vaporize when the lowered static pressure reaches the saturated vapor pressure of the liquid. Such a phenomenon in which a liquid is rapidly vaporized because the static pressure becomes lower than the saturated vapor pressure (for water, 3000 to 4000 Pa) in extremely short time at almost constant temperature is called cavitation. The internal structure of the fluid supply pipe 10 of the present invention causes the cavitation phenomenon. Due to the cavitation phenomenon, the liquid is boiled with minute bubbles of a particle size less than 100 microns existing in the liquid as nuclei or many minute bubbles are generated due to isolation of dissolved gas. That is, many micro bubbles are generated while the fluid passes the bubble generating portion 26.

In the case of water, one water molecule can form hydrogen bonds with four other water molecules, and this hydrogen bonding network is not easy to break down. Thus, the water has much higher boiling point and melting point than other liquids that do not form hydrogen bonds, and is highly viscous. Since the water having the high boiling point exhibits an excellent cooling effect, the water is frequently used as the coolant for the machine tool for performing operations such as grinding. However, the water has a problem that the size of the water molecule is large and its penetration to a machining spot and/or lubricity is not so good. Thus, conventionally, a special lubricant (i.e. cutting oil) other than the water is frequently used alone or mixed with the water. In the case of using the fluid supply pipe of the present invention, the cavitation phenomenon described above causes vaporization of the water and, as a result, the hydrogen bonding network of the water is destroyed to lower the viscosity. Further, the micro bubbles generated by the vaporization improve the penetration and lubricity. The improved penetration results in increased cooling efficiency. Therefore, according to the embodiment of the present invention, it is possible to improve machining quality (i.e. the performance of the machine tool) even if only water is used without using a special lubricant.

The fluid which has passed the bubble generating unit 26 enters the tapered portion 37 of the outlet side member 34. Since the tapered portion 37 has a flow path whose cross section is much larger than that of the bubble generating portion 26, the flip-flop phenomenon almost disappears in the tapered portion 37. The fluid flows out of the outlet 9 after passing through the tapered portion 37, and is discharged toward the grinding spot G through the nozzle 7. When the fluid is discharged through the nozzle 7, the many micro bubbles generated in the bubble generating portion 26 are exposed to atmospheric pressure. Then, the micro bubbles collide with the grinding blade 2 and the workpiece 3 and break, or explode and disappear. Vibration and shock generated during the extinction of the bubbles effectively remove sludge or chips generated at the grinding spot G. In other words, the cleaning effect around the grinding spot G is improved as the micro bubbles disappear.

By providing the fluid supply unit of the machine tool with the fluid supply pipe 10 of the embodiment of the present invention, it is possible to cool the heat generated in the grinding blade and the workpiece more effectively than by using a conventional fluid supply unit. Further, the permeability and lubricity of the fluid are improved, thereby enhancing the precision of machining. Furthermore, by effectively removing the debris of the workpiece from the machining spot, it is possible to extend the service life of the tool such as the cutting blade and reduce the cost of replacing the tool.

In addition, since the fluid diffusing portion 22, the swirl generating portion 24, and the bubble generating portion 26 of the internal structure 20 are formed by processing one member according to the present embodiment, the internal structure 20 is manufactured as a single integrated component. Therefore, it is possible to manufacture the fluid supply pipe 10 only by a simple process of inserting the internal structure 20 into the outlet side member 34 and then engaging the male screw 35 of the outlet side member 34 with the female screw 32 of the inlet side member 31.

The fluid supply pipe of the present invention can be applied to a machining liquid supply unit in various machine tools such as the grinding machine, the cutting machine, and the drilling machine. In addition, the fluid supply pipe of the present invention can be effectively used in an apparatus for mixing two or more kinds of fluids (liquid and liquid, liquid and gas, or gas and gas). For example, in the case of applying the fluid supply pipe of the present invention to a combustion engine, combustion efficiency can be improved by sufficiently mixing fuel and air. Further, in the case of applying the fluid supply pipe of the present invention to a cleaning apparatus, a cleaning effect can be further improved compared to a conventional cleaning apparatus.

### Second Embodiment

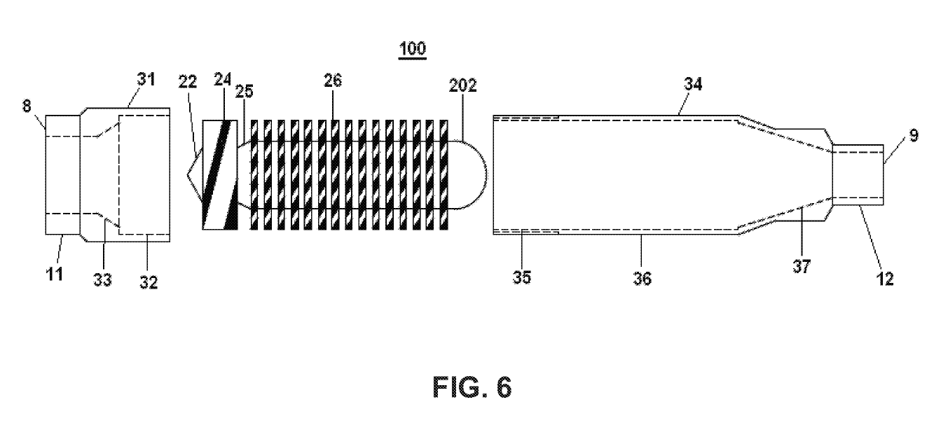

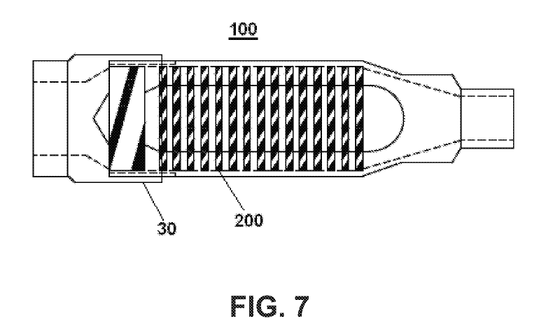

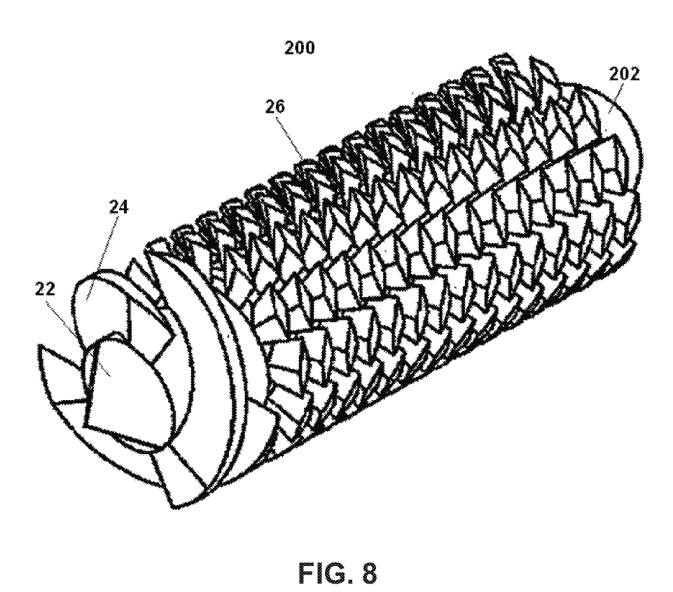

Referring to FIGS. 6 to 8, a fluid supply pipe 100 according to a second embodiment of the present invention will be described below. Descriptions of the same features as those of the first embodiment will be omitted, and only differences from the first embodiment will be described in detail. The same reference numerals are used for the same features as those of the first embodiment. FIG. 6 is a side exploded view of the fluid supply pipe 100, FIG. 7 is a side sectional view of the fluid supply pipe 100, and FIG. 8 is a three-dimensional perspective view of an internal structure 200 of the fluid supply pipe 100 according to the second embodiment of the present invention. As shown in FIGS. 6 and 7, the fluid supply pipe 100 includes the internal structure 200 and the pipe body 30. Since the pipe body 30 of the second embodiment is the same as that of the first embodiment, descriptions thereof will be omitted. In FIGS. 6 and 7, a fluid flows from the inlet 8 to the outlet 9.

The internal structure 200 of the second embodiment is formed by machining a cylindrical member made of a metal, for example, and includes the fluid diffusing portion 22, the swirl generating portion 24, the bubble generating portion 26, and a dome-shaped guiding portion 202 from the upstream side to the downstream side. As described with respect to the first embodiment, the fluid diffusing portion 22 is formed by machining one end of the cylindrical member in the cone shape.

The internal structure 20 of the first embodiment includes the bubble generating portion 26 formed by machining the surface of the downstream portion of the cylindrical member, but its end is not specially machined. On the other hand, the internal structure 200 of the second embodiment includes the guiding portion 202 formed by machining the downstream end of the cylindrical member in a dome shape.

As shown in FIGS. 6 and 7, the fluid supply pipe 100 is assembled by inserting the internal structure 200 into the outlet side member 34 and engaging the male screw 35 of the outer circumferential surface of the outlet side member 34 with the female screw 32 of the inner circumferential surface of the inlet side member 31. In the following, flow of the fluid in the fluid supply pipe 100 assembled as above is described. The fluid entering the inlet 8 of the fluid supply pipe 100 through the delivery pipe 6 (see FIG. 1) bumps into the fluid diffusing portion 22 and diffuses outward from the center of the fluid supply pipe 100 (i.e. radially) while passing through the inner space of the tapered portion 33 of the inlet side member 31. The diffused fluid vigorously swirls while passing between the three vanes of the swirl generating portion 24 formed in the spiral shape and is sent to the bubble generating portion 26. Then, the fluid passes between the plurality of narrow flow paths formed by the plurality of rhombic protrusions formed regularly on the outer circumferential surface of the shaft portion of the bubble generating portion 26. Here, due to the flip-flop phenomenon and the cavitation phenomenon, the large number of minute vortices and the micro bubbles are generated.

When the fluid flows from the plurality of narrow flow paths formed on the surface of the bubble generating portion 26 to the tapered portion 37 of the outlet side member 34, the flow path is rapidly expanded. Thus, the flip-flop phenomenon induced by the bubble generating portion 26 is almost eliminated and a Coanda effect occurs. The Coanda effect is the phenomenon in which a fluid flowing around a curved surface is drawn to the curved surface due to a pressure drop between the fluid and the curved surface and thus the fluid flows along the curved surface. Due to the Coanda effect, the fluid is induced to flow along the surface of the guiding portion 202. The fluid guided toward the center by the dome-shaped guiding portion 202 passes through the tapered portion 37 and flows out of the outlet 9. The fluid discharged from the fluid supply pipe 100 adheres well to the cutting blade or the surface of the workpiece due to the Coanda effect amplified by the guiding portion 202 of the internal structure 200, which increases the cooling effect of the fluid.

### Third Embodiment

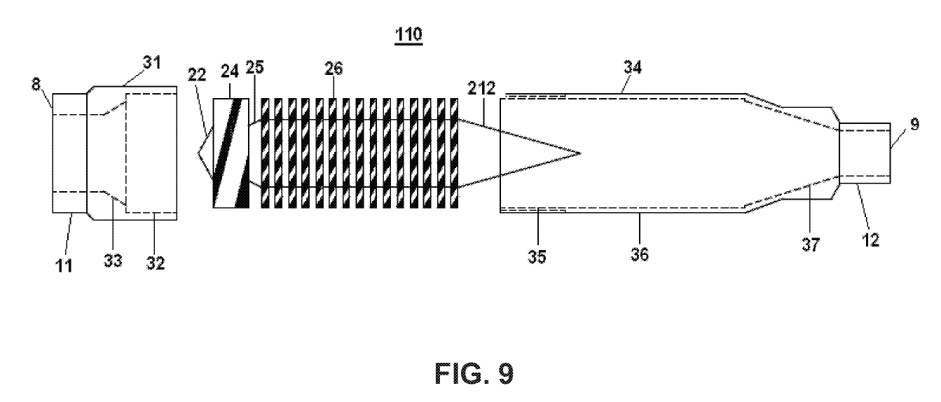

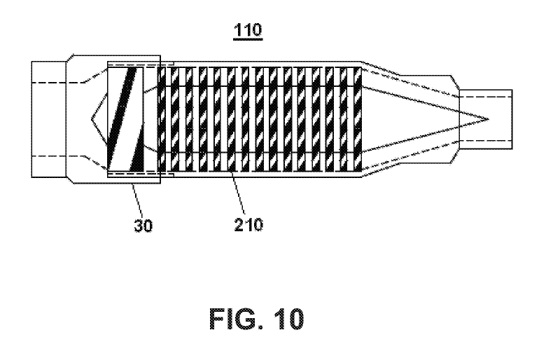

Referring to FIGS. 9 and 10, a fluid supply pipe 110 according to a third embodiment of the present invention will be described below. Descriptions of the same features as those of the first and second embodiments will be omitted, and only differences from the first and second embodiments will be described in detail. The same reference numerals are used for the same features as those of the first and second embodiments. FIG. 9 is a side exploded view of the fluid supply pipe 110, and FIG. 10 is a side sectional view of the fluid supply pipe 110 according to the third embodiment of the present invention. As shown in FIGS. 9 and 10, the fluid supply pipe 110 includes an internal structure 210 and the pipe body 30. Since the pipe body 30 of the third embodiment is the same as that of the first embodiment, descriptions thereof will be omitted. In FIGS. 9 and 10, a fluid flows from the inlet 8 to the outlet 9.

The internal structure 210 of the third embodiment is formed by machining a cylindrical member made of a metal, for example, and includes the fluid diffusing portion 22, the swirl generating portion 24, the bubble generating portion 26, and a cone-shaped guiding portion 212 from the upstream side to the downstream side. As described with respect to the first embodiment, the fluid diffusing portion 22 is formed by machining one end of the cylindrical member in the cone shape.

The internal structure 20 of the first embodiment includes no guiding portion in the other end, and the internal structure 200 of the second embodiment includes the guiding portion 202 formed by machining the downstream end of the cylindrical member in the dome shape. On the other hand, the internal structure 210 of the third embodiment includes the guiding portion 212 formed by machining the downstream end of the cylindrical member in a cone shape, as shown in FIGS. 9 and 10.

As shown in FIG. 10, the fluid supply pipe 110 is assembled by inserting the internal structure 210 into the outlet side member 34 and engaging the male screw 35 of the outer circumferential surface of the outlet side member 34 with the female screw 32 of the inner circumferential surface of the inlet side member 31. In the following, flow of the fluid in the fluid supply pipe 110 assembled as above is described. The fluid entering the inlet 8 of the fluid supply pipe 110 through the delivery pipe 6 (see FIG. 1) bumps into the fluid diffusing portion 22, and diffuses outward from the center of the fluid supply pipe 110 while passing through the inner space of the tapered portion 33 of the inlet side member 31. The diffused fluid vigorously swirls while passing between the three vanes of the swirl generating portion 24 formed in the spiral shape and is sent to the bubble generating portion 26. Then, the fluid passes between the plurality of narrow flow paths formed by the plurality of rhombic protrusions formed regularly on the outer circumferential surface of the shaft portion of the bubble generating portion 26. Here, due to the flip-flop phenomenon and the cavitation phenomenon, the large number of minute vortices and the micro bubbles are generated.

After passing the bubble generating portion 26, the fluid flows toward the end of the internal structure 210. Due to the Coanda effect, the fluid is induced to flow along the surface of the guiding portion 212. The fluid guided toward the center by the guiding portion 212 passes through the tapered portion 37 and flows out of the outlet 9. As described with respect to the second embodiment, the fluid discharged from the fluid supply pipe 110 adheres well to the cutting blade or the surface of the workpiece due to the Coanda effect amplified by the guiding portion 212 of the internal structure 210, which increases the cooling effect of the fluid.

### Fourth Embodiment

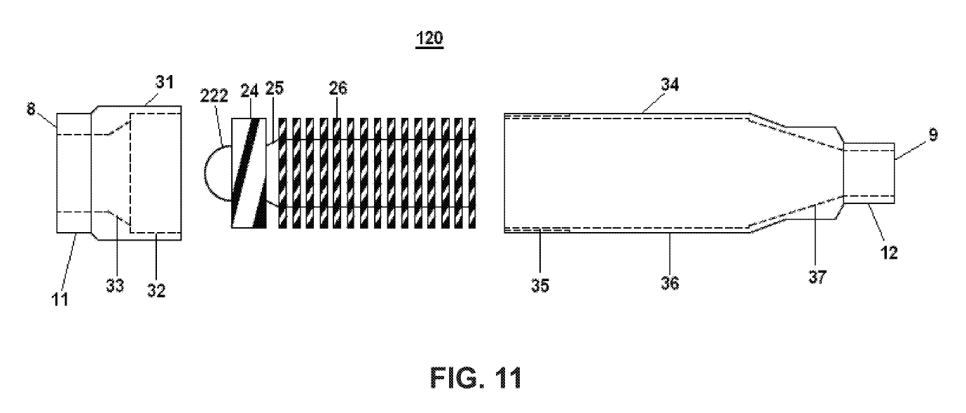

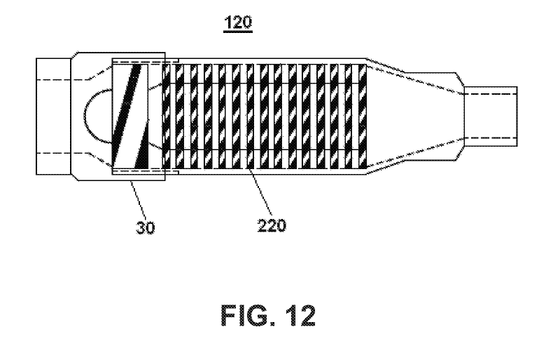

Referring to FIGS. 11 and 12, a fluid supply pipe 120 according to a fourth embodiment of the present invention will be described below. Descriptions of the same features as those of the first embodiment will be omitted, and only differences from the first embodiment will be described in detail. The same reference numerals are used for the same features as those of the first embodiment. FIG. 11 is a side exploded view of the fluid supply pipe 120, and FIG. 12 is a side sectional view of the fluid supply pipe 120 according to the fourth embodiment of the present invention. As shown in FIGS. 11 and 12, the fluid supply pipe 120 includes an internal structure 220 and the pipe body 30. Since the pipe body 30 of the fourth embodiment is the same as that of the first embodiment, descriptions thereof will be omitted. In FIGS. 11 and 12, a fluid flows from the inlet 8 to the outlet 9.

The internal structure 220 of the fourth embodiment is formed by machining a cylindrical member made of a metal, for example, and includes a fluid diffusing portion 222, the swirl generating portion 24, and the bubble generating portion 26 from the upstream side to the downstream side. While the internal structure 20 according to the first embodiment includes the fluid diffusing portion 22 formed in the cone shape in the front end, the internal structure 220 according to the fourth embodiment includes the fluid diffusing portion 222 formed in a dome shape in the front end. The fluid diffusing portion 222 is formed by machining one end of the cylindrical member in the dome shape. The swirl generating portion 24 includes the shaft portion having the circular cross-section and the three spiral vanes. The bubble generating portion 26 includes the plurality of rhombic protrusions formed in the net shape on the outer circumferential surface of the shaft portion having the circular cross-section.

The fluid diffusing portion 222 diffuses the fluid flowing into the inlet side member 31 through the inlet 8 outward from the center of the pipe. The fluid flows toward the dome-shaped fluid diffusing portion 222, and flows along the surface of the fluid diffusing portion 222 due to the Coanda effect. Thus, it is possible to diffuse the fluid outward while minimizing loss of kinetic energy of the fluid. The fluid supply pipe 120 can improve the cooling effect and the cleaning effect of the coolant compared to a conventional pipe.

### Fifth Embodiment

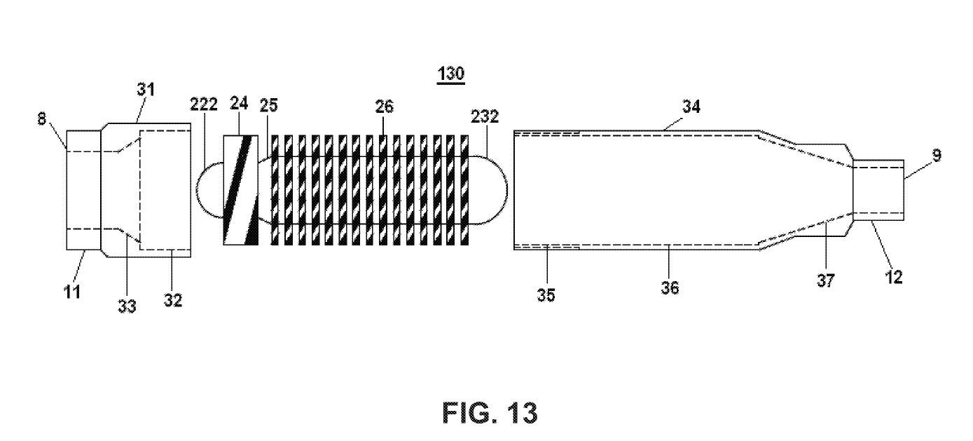

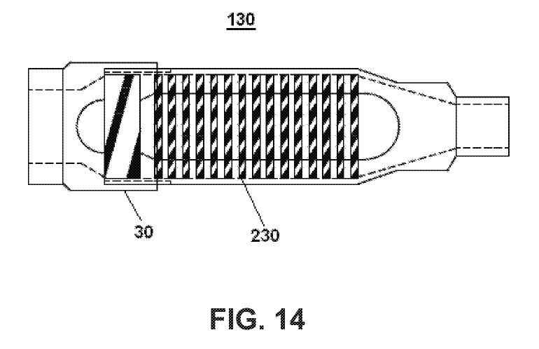

Referring to FIGS. 13 and 14, a fluid supply pipe 130 according to a fifth embodiment of the present invention will be described below. Descriptions of the same features as those of the first and fourth embodiments will be omitted, and the same reference numerals are used for the same features as those of the first and fourth embodiments. FIG. 13 is a side exploded view of the fluid supply pipe 130, and FIG. 14 is a side sectional view of the fluid supply pipe 130 according to the fifth embodiment of the present invention. As shown in FIGS. 13 and 14, the fluid supply pipe 130 includes an internal structure 230 and the pipe body 30. Since the pipe body 30 of the fifth embodiment is the same as that of the first embodiment, descriptions thereof will be omitted. In FIGS. 13 and 14, a fluid flows from the inlet 8 to the outlet 9.

The internal structure 230 of the fifth embodiment is formed by machining a cylindrical member made of a metal, for example, and includes the dome-shaped fluid diffusing portion 222, the swirl generating portion 24, the bubble generating portion 26, and a dome-shaped guiding portion 232 from the upstream side to the downstream side.

In FIGS. 13 and 14, the fluid flowing into the fluid supply pipe 130 through the inlet 8 flows toward the dome-shaped fluid diffusing portion 222. The fluid flows along the surface of the fluid diffusing portion 222 due to the Coanda effect and diffuses outward from the center of the fluid supply pipe 130. The dome shape can diffuse the fluid outward while minimizing loss of kinetic energy of the fluid. Then, the fluid passes the swirl generating portion 24 and the bubble generating portion 26 and flows along the surface of the dome-shaped guiding portion 232. The fluid guided toward the center by the dome-shaped guiding portion 232 passes through the tapered portion 37 and flows out of the outlet 9. The fluid supply pipe 130 can improve the cooling effect and the cleaning effect of the coolant compared to the conventional pipe.

### Sixth Embodiment

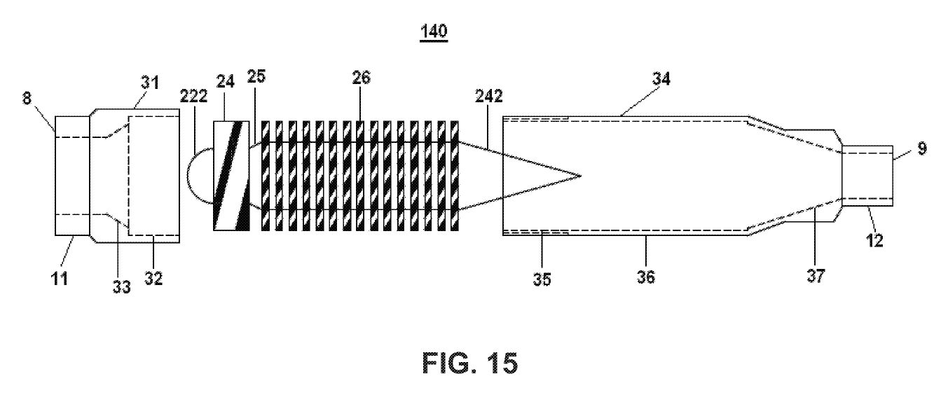

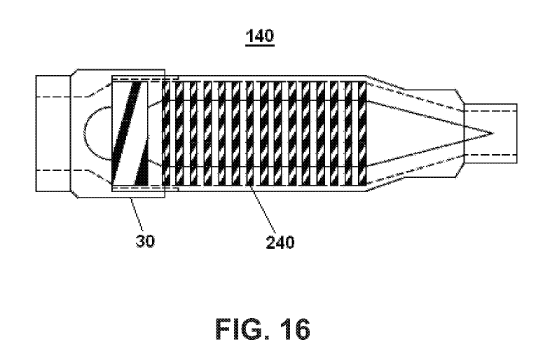

Referring to FIGS. 15 and 16, a fluid supply pipe 140 according to a sixth embodiment of the present invention will be described below. Descriptions of the same features as those of the first and fourth embodiments will be omitted, and the same reference numerals are used for the same features as those of the first and fourth embodiments. FIG. 15 is a side exploded view of the fluid supply pipe 140, and FIG. 16 is a side sectional view of the fluid supply pipe 140 according to the sixth embodiment of the present invention. As shown in FIGS. 15 and 16, the fluid supply pipe 140 includes an internal structure 240 and the pipe body 30. Since the pipe body 30 of the sixth embodiment is the same as that of the first embodiment, descriptions thereof will be omitted. In FIGS. 15 and 16, a fluid flows from the inlet 8 to the outlet 9.

The internal structure 240 of the sixth embodiment is formed by machining a cylindrical member made of a metal, for example, and includes the dome-shaped fluid diffusing portion 222, the swirl generating portion 24, the bubble generating portion 26, and a cone-shaped guiding portion 242 from the upstream side to the downstream side.

In FIGS. 15 and 16, the fluid flowing into the fluid supply pipe 140 through the inlet 8 flows toward the dome-shaped fluid diffusing portion 222. The fluid flows along the surface of the fluid diffusing portion 222 due to the Coanda effect and diffuses outward from the center of the fluid supply pipe 140. The dome shape can diffuse the fluid outward while minimizing loss of kinetic energy of the fluid. Then, the fluid passes the swirl generating portion 24 and the bubble generating portion 26 and flows along the surface of the cone-shaped guiding portion 242. The fluid guided toward the center by the cone-shaped guiding portion 242 passes through the tapered portion 37 and flows out of the outlet 9. The fluid supply pipe 140 can improve the cooling effect and the cleaning effect of the coolant compared to the conventional pipe.

Although some embodiments of the present invention have been described above, the embodiments are for illustrative purposes only and not intended to limit the technical scope of the present invention. It will be apparent to those skilled in the art that many other possible embodiments and various modifications of the present invention may be made in light of the specification and drawings. Although a plurality of specific terms are used herein, they are used in a generic sense only for the purpose of explanation and are not used for the purpose of limiting the invention. The embodiments and modifications fall within the scope and the spirit of the invention described in this specification and within the scope of the invention as defined in the appended claims and equivalents thereof.

What is claimed is:

1. A fluid supply pipe comprising:
an internal structure; and
a pipe body configured to house the internal structure, the pipe body having an inlet and an outlet and having a circular cross-section, and
the internal structure comprising:
a first portion for diffusing a fluid flowing into the fluid supply pipe through the inlet radially from the center of the fluid supply pipe, the first portion being placed in the inlet side of the pipe body when the internal structure is housed in the pipe body;
a second portion placed downstream from the first portion and comprising a plurality of spiral vanes to swirl the fluid diffused by the first portion; and
a third portion placed downstream from the second portion and comprising a plurality of protrusions on its outer circumferential surface.

2. The fluid supply pipe of claim 1, wherein at least one of the first portion, the second portion and the third portion of the internal structure has a circular cross-section.

3. The fluid supply pipe of claim 1, wherein the first portion of the internal structure is one end of the internal structure formed in a cone shape.

4. The fluid supply pipe of claim 1, wherein the first portion of the internal structure is one end of the internal structure formed in a dome shape.

5. The fluid supply pipe of claim 1, wherein the second portion of the internal structure comprises a shaft portion having a circular cross-section and the plurality of spiral vanes.

6. The fluid supply pipe of claim 5, wherein the second portion of the internal structure comprises three vanes and each of the vanes has its end spaced by 120 degrees from each other in the circumferential direction of the shaft portion.

7. The fluid supply pipe of claim 1, wherein the third portion of the internal structure comprises a shaft portion having a circular cross-section and a plurality of rhombic protrusions formed on an outer circumferential surface of the shaft portion.

8. The fluid supply pipe of claim 7, wherein the plurality of rhombic protrusions are formed in a net shape.

9. The fluid supply pipe of claim 1, wherein the internal structure comprises a fourth portion placed downstream from the third portion for guiding the fluid toward the center of the fluid supply pipe.

10. The fluid supply pipe of claim 9, wherein the fourth portion of the internal structure is one end of the internal structure formed in a dome shape.

11. The fluid supply pipe of claim 9, wherein the fourth portion of the internal structure is one end of the internal structure formed in a cone shape.

12. The fluid supply pipe of claim 1, wherein the radius of a portion of the first portion of the internal structure of which cross-sectional area is the maximum, is smaller than the distance from the center of a shaft portion of the second portion to the end of each of the vanes.

13. The fluid supply pipe of claim 1, wherein the pipe body is composed of an inlet side member and an outlet side member, and the inlet side member and the outlet side member are connected by screw-joining.

14. An internal structure of a fluid supply pipe, the fluid supply pipe comprising a pipe body having an inlet and an outlet and a circular cross-section, comprising:
a first portion for diffusing a fluid flowing into the fluid supply pipe through the inlet radially from the center of the fluid supply pipe, the first portion being placed in the inlet side of the pipe body when the internal structure is housed in the pipe body;
a second portion placed downstream from the first portion and comprising a plurality of spiral vanes to swirl the fluid diffused by the first portion; and
a third portion placed downstream from the second portion and comprising a plurality of protrusions on its outer circumferential surface.

15. A machine tool comprising:
a fluid supply pipe of claim 1,
wherein the machine tool allows coolant to flow into the fluid supply pipe to apply a predetermined flow characteristic to the coolant and discharges the coolant from the fluid supply pipe to a tool or a workpiece to cool it.

16. A shower nozzle comprising:
a fluid supply pipe of claim 1,
wherein the shower nozzle allows water of a predetermined temperature to flow into the fluid supply pipe to apply a predetermined flow characteristic to the water and discharges the water from the fluid supply pipe to improve a cleaning effect.

17. A fluid mixing apparatus comprising:
a fluid supply pipe of claim 1,
wherein the fluid mixing apparatus allows a plurality of fluids having different properties to flow into the fluid supply pipe to apply a predetermined flow characteristic to the fluids to mix them and discharges the mixed fluids.

18. An internal structure of a fluid supply pipe, the fluid supply pipe comprising a pipe body having an inlet and an outlet, comprising:
a fluid diffusing portion for diffusing a fluid flowing into the fluid supply pipe through the inlet radially from the center of the fluid supply pipe, the fluid diffusing portion being placed in the inlet side of the pipe body when the internal structure is housed in the pipe body;
a swirl generating portion placed downstream from the fluid diffusion portion for swirling the fluid diffused by the fluid diffusion portion; and
a bubble generating portion placed downstream from the swirl generating portion for generating multi bubbles in the fluid swirled by the swirl generating portion.

19. The internal structure of the fluid supply pipe of claim 18, further comprising:
a guiding portion placed downstream from the bubble generating portion for guiding the fluid toward the center of the fluid supply pipe.

20. The internal structure of the fluid supply pipe of claim 18, wherein the fluid diffusing portion, the swirl generating portion, and the bubble generating portion are formed on a common cylindrical member.

21. The internal structure of the fluid supply pipe of claim 19, wherein the fluid diffusing portion, the swirl generating portion, the bubble generating portion and the guiding portion are formed on a common cylindrical member.
